(19) United States
(12) Patent Application Publication
(10) Pub. No.: US 2026/0266080 A1
(43) Pub. Date: Sep. 10, 2026

(54) WATER SURFACE CLEANING MACHINE

(71) Applicants: Hai Liu, Foshan (CN); Qifeng Wu, Foshan (CN)

(72) Inventors: Hai Liu, Foshan (CN); Qifeng Wu, Foshan (CN)

(21) Appl. No.: 19/071,924

(22) Filed: Mar. 6, 2025

(51) Int. Cl. E04H 4/16; H02K 49/10

(52) U.S. Cl. CPC E04H 4/1654; H02K 49/102

(57) ABSTRACT

The present application provides a water surface cleaning machine, including a machine body, a drive assembly, and a roller brush assembly. The machine body includes a housing and a sealed casing that is arranged inside the housing and isolated from an outside. A first drive member is arranged inside the sealed casing, and a second drive member is arranged inside the housing and is arranged outside the sealed casing. The first drive member is magnetically connected with the second drive member. In the water surface cleaning machine provided above, two drive members are associated through magnetic driving. The first drive member is completely sealed in the sealed casing, and the second drive member rotates only under magnetic driving, which fundamentally solves the risk that a water vapor penetrates into a motor due to the failed dynamic sealing.

### TECHNICAL FIELD

The present application relates to the technical field of swimming pool-cleaning devices, and in particular relates to a water surface cleaning machine.

### BACKGROUND

With the improvement of people's requirements for the water quality in swimming pools, it has become particularly important to keep a water surface in a swimming pool clean. However, clutters such as fallen leaves, branches, and flowers easily fall to water surfaces in outdoor swimming pools. If not cleaned up in time, these clutters not only affect the appearance, but also may clog a filtration system to affect the normal use of a swimming pool.

In the existing water surface cleaning machines, a gear transmission mechanism is usually adopted, and a roller brush assembly is driven by a motor to rotate, thereby introducing the garbage on a water surface into a garbage collection basket. The roller brush assembly generally adopts hard plastic brush blades, which can effectively roll up floating objects on a water surface during a rotation and smoothly collect the floating objects in a storage bin. Compared with the manual collection, this cleaning method has the automation advantage and can continuously clean up the garbage on a water surface, which improves the convenience of maintenance for swimming pools.

However, the current water surface cleaning machines still have many deficiencies in terms of water proofing for motors. A gear transmission mechanism can effectively drive a roller brush assembly, but has a complicated structure, which increases the risk of a motor to contact water. Once the sealing is incomplete, a water vapor may penetrate into a motor along a transmission shaft, resulting in short-circuiting or corrosion. Moreover, in the existing machines, a sealing ring is arranged on a transmission shaft to protect a motor. The sealing against a moving component, such as sleeving a sealing ring on a motor shaft, is dynamic sealing. Because the motor shaft runs at a high speed and rubs with the sealing ring, the failure probability of the sealing ring is high, which increases the risk of water vapor penetration. Therefore, a roller brush structure that can well prevent a water vapor from penetrating into a motor of a water surface cleaning machine is required to solve the above problems.

### SUMMARY

In view of this, it is necessary to provide a water surface cleaning machine that can well prevent a water vapor from penetrating into a motor to solve the above problems.

An embodiment of the present application provides a water surface cleaning machine, including:
a machine body, including a housing and a sealed casing that is arranged inside the housing and isolated from an outside;
a drive assembly, including a first drive member and a second drive member, where the first drive member is arranged inside the sealed casing, the second drive member is arranged inside the housing and is arranged outside the sealed casing, and the first drive member is magnetically connected with the second drive member; and
a roller brush assembly that is arranged on the second drive member and is configured to rotate with the second drive member when the first drive member operates.

In at least one embodiment of the present application, the first drive member includes a motor arranged in the sealed casing and a first magnetic ring in a transmission connection with the motor, and the first magnetic ring is in bearing-type connection with the sealed casing; and
the second drive member includes a second magnetic ring, central axes of the first magnetic ring and the second magnetic ring are located on a same straight line, and there is a gap between the second magnetic ring and the sealed casing.

In at least one embodiment of the present application, the first magnetic ring includes a first supporting member and a plurality of first magnets arranged circularly on the first supporting member, and a first separator is provided between two adjacent first magnets; and
the second magnetic ring includes a second supporting member and a plurality of second magnets arranged circularly on the second supporting member, and a second separator is provided between two adjacent second magnets; and each first magnet directly faces a corresponding second magnet, and the plurality of first magnets have an opposite magnetic pole to the plurality of second magnets.

In at least one embodiment of the present application, each of the plurality of first magnets includes a positive pole portion and a negative pole portion, and the positive pole portions and the negative pole portions, facing one side of the second magnet, of the plurality of first magnets are staggered.

In at least one embodiment of the present application, the sealed casing includes a separating portion and a first casing and a second casing that are arranged at two sides of the separating portion, respectively; the first casing and the separating portion enclose a first cavity, and the second casing and the separating portion enclose a second cavity; and
the motor is arranged in the first cavity and partially extends into the second cavity, and the first magnetic ring is arranged in the second cavity.

In at least one embodiment of the present application, a first sealing groove and a second sealing groove are annularly formed at two opposite sides of the separating portion, respectively; and
the drive assembly further includes a sealing member, and the sealing member is arranged in the first sealing groove and the second sealing groove; and the first casing extends into the first sealing groove and is in an interference fit with the sealing member, and the second casing extends into the second sealing groove and is in an interference fit with the sealing member.

In at least one embodiment of the present application, the first casing includes a body and a clamping portion integrally formed with the body; a side of the first casing that is close to the separating portion extends outwards to produce the clamping portion; the clamping portion clamps the separating portion; and
the drive assembly further includes a fixing member, and the fixing member is arranged to penetrate through the first casing, the separating portion, and the second casing successively and is configured to fix the first casing, the separating portion, and the second casing.

In at least one embodiment of the present application, the roller brush assembly includes a roller brush shaft and flexible roller brush blades arranged circularly on the roller brush shaft, and the second drive member is fixedly connected with the roller brush shaft; and
the roller brush shaft includes a cylinder and end covers; fixing grooves are formed annularly and circumferentially on the cylinder in a length direction of the cylinder; the end covers cover two ends of the cylinder respectively to enclose two ends of each fixing groove; and the flexible roller brush blades are arranged in the fixing grooves.

In at least one embodiment of the present application, the water surface cleaning machine further includes a storage bin, where the storage bin is slidably connected with the housing; the roller brush assembly is arranged on the storage bin and partially extends out of a side wall of the storage bin; and two ends of the roller brush assembly are in bearing-type connection with the side wall of the storage bin, respectively.

In at least one embodiment of the present application, the storage bin further includes a storage portion and a blocking portion; the roller brush assembly is arranged on the storage portion; and the blocking portion is arranged at an end of the storage portion that is close to the roller brush assembly, and is configured to prevent clutters from entering a shaft connection between the roller brush assembly and the storage portion.

In the water surface cleaning machine provided above, the first drive member and the second drive member are associated through a magnetic driving mode, which completely abandons the transmission shaft and dynamic sealing structures required by the traditional gear transmission. The first drive member is completely sealed in the sealed casing, and the second drive member rotates only under magnetic driving, which completely avoids the friction and wear between the traditional transmission shaft and sealing ring, fundamentally solves the risk that a water vapor penetrates into a motor due to the failed dynamic sealing, and can significantly improve the water proofing reliability and service life of a motor. In the present application, the complicated gear transmission structure in the prior art is replaced by magnetic driving. There is no mechanical connection component between the sealed casing and the housing, and the complete isolation of a motor from an external water environment can be achieved merely through the static sealing for the sealed casing.

### BRIEF DESCRIPTION OF THE DRAWINGS

FIG. 1 is a three-dimensional view of a water surface cleaning machine in an embodiment of the present application;

FIG. 2 is a cross-sectional view of the water surface cleaning machine in FIG. 1;

FIG. 3 is an enlarged view of a cross section of a portion A of the water surface cleaning machine in FIG. 2;

FIG. 4 is a three-dimensional view of a storage bin of the water surface cleaning machine in FIG. 1;

FIG. 5 is a cross-sectional view of the storage bin in FIG. 4;

FIG. 6 is a three-dimensional view of a machine body of the water surface cleaning machine in FIG. 1;

FIG. 7 is a three-dimensional view of a sealed casing of the water surface cleaning machine in FIG. 6;

FIG. 8 is a three-dimensional exploded view of the sealed casing in FIG. 7;

FIG. 9 is a cross-sectional view of the sealed casing in FIG. 7;

FIG. 10 is a three-dimensional view of a first magnetic ring and a second magnetic ring of the water surface cleaning machine in FIG. 1;

FIG. 11 is a three-dimensional view of another embodiment of the magnetic rings in FIG. 10;

FIG. 12 is a three-dimensional exploded view of a roller brush assembly of the water surface cleaning machine in FIG. 1; and

FIG. 13 is an enlarged view of a portion B of the roller brush assembly in FIG. 12.

### REFERENCE NUMERALS

100. water surface cleaning machine; 10. machine body; 11. housing; 12. sealed casing; 121. first casing; 121a. body; 121b. clamping portion; 122. second casing; 123. separating portion; 123a. first sealing groove; 123b. second sealing groove; 124. first cavity; 125. second cavity; 20. drive assembly; 21. first drive member; 211. motor; 212. first magnetic ring; 212a. first supporting member; 212b. first magnet; 212c. first separator; 22. second drive member; 221. second magnetic ring; 221a. second supporting member; 221b. second magnet; 221c. second separator; 23. gap; 24. sealing member; 25. fixing member; 30. roller brush assembly; 31. roller brush shaft; 311. cylinder; 312. end cover; 313. fixing groove; 32. flexible roller brush blade; 40. storage bin; 41. storage portion; and 42. blocking portion.

### DETAILED DESCRIPTION OF THE EMBODIMENTS

The embodiments of the present application are described below with reference to the accompanying drawings in the embodiments of the present application. Apparently, the embodiments described are merely some rather than all of the embodiments of the present application.

It should be noted that when a component is “connected” to another component, the component may be connected to the another component directly or indirectly through an intermediate component. When a component is “arranged on” another component, the component may be arranged on the another component directly or indirectly through an intermediate component. The terms “top”, “bottom”, “up”, “down”, “left”, “right”, “front”, and “back” and similar expressions used herein are for illustrative purposes only.

An embodiment of the present application provides a water surface cleaning machine, including:
a machine body, including a housing and a sealed casing that is arranged inside the housing and isolated from an outside;
a drive assembly, including a first drive member and a second drive member, where the first drive member is arranged inside the sealed casing, the second drive member is arranged inside the housing and is arranged outside the sealed casing, and the first drive member is magnetically connected with the second drive member; and
a roller brush assembly that is arranged on the second drive member and is configured to rotate with the second drive member when the first drive member operates.

In the water surface cleaning machine provided above, the first drive member and the second drive member are associated through a magnetic driving mode, which completely abandons the transmission shaft and dynamic sealing structures required by the traditional gear transmission. The first drive member is completely sealed in the sealed casing, and the second drive member rotates only under magnetic driving, which completely avoids the friction and wear between the traditional transmission shaft and sealing ring, fundamentally solves the risk that a water vapor penetrates into a motor due to the failed dynamic sealing, and can significantly improve the water proofing reliability and service life of a motor. In the present application, the complicated gear transmission structure in the prior art is replaced by magnetic driving. There is no mechanical connection component between the sealed casing and the housing, and the complete isolation of a motor from an external water environment can be achieved merely through the static sealing for the sealed casing.

Some embodiments of the present application are described in detail below with reference to the accompanying drawings. If no conflict occurs, the following embodiments and the features in the embodiments may be combined with each other.

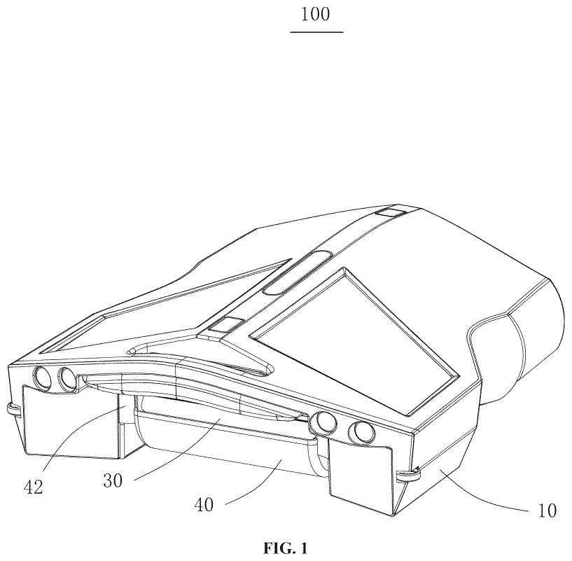

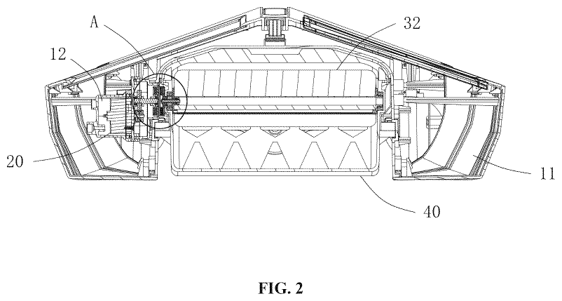

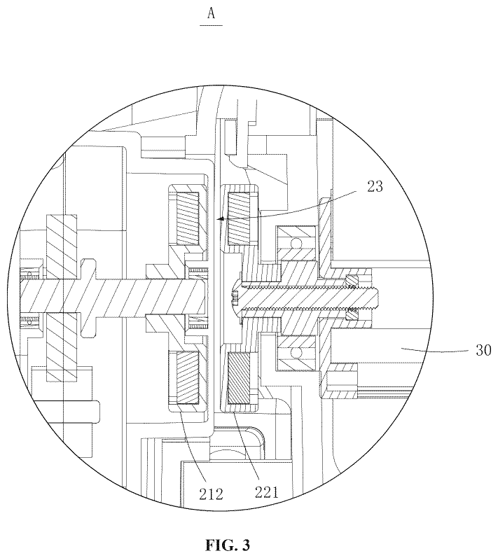

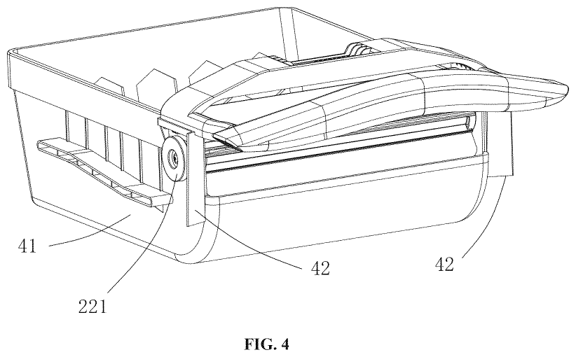

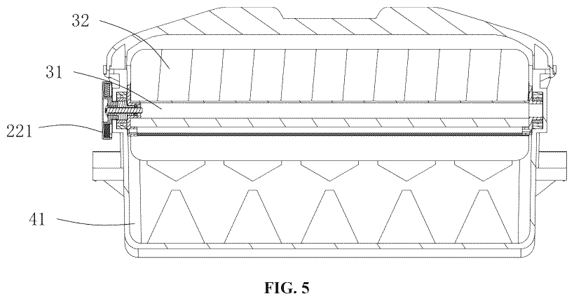

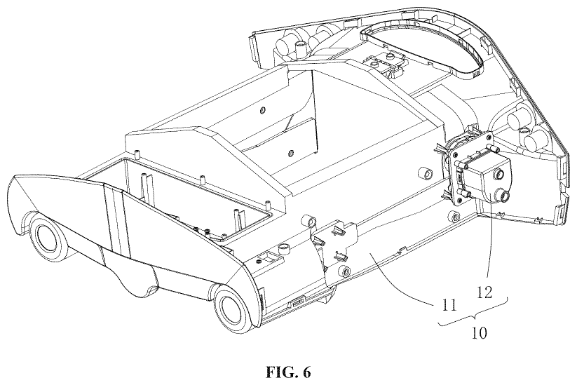

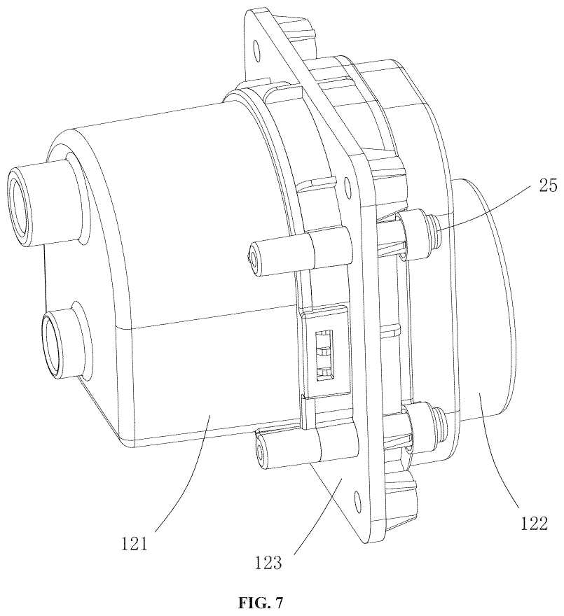

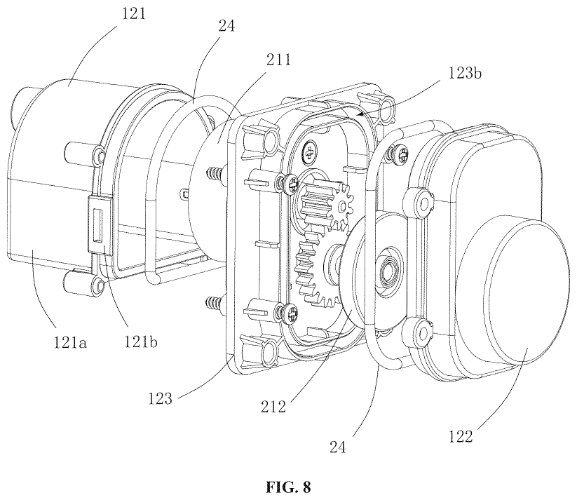

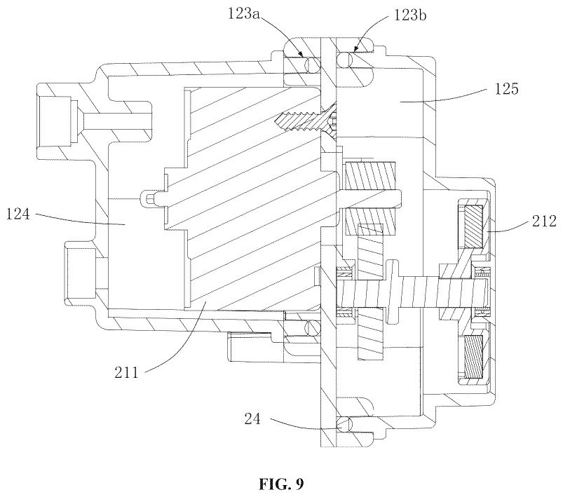

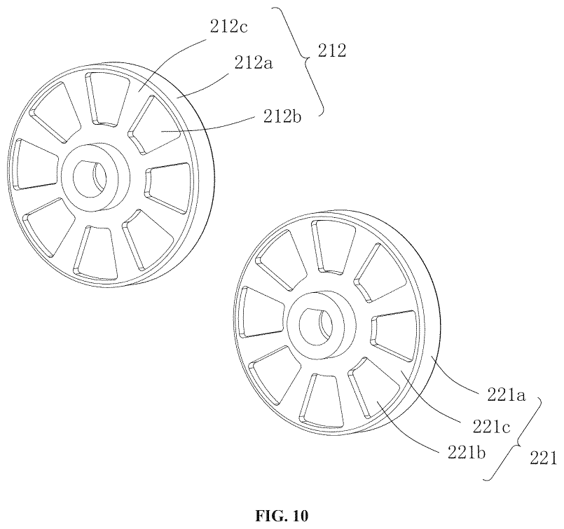

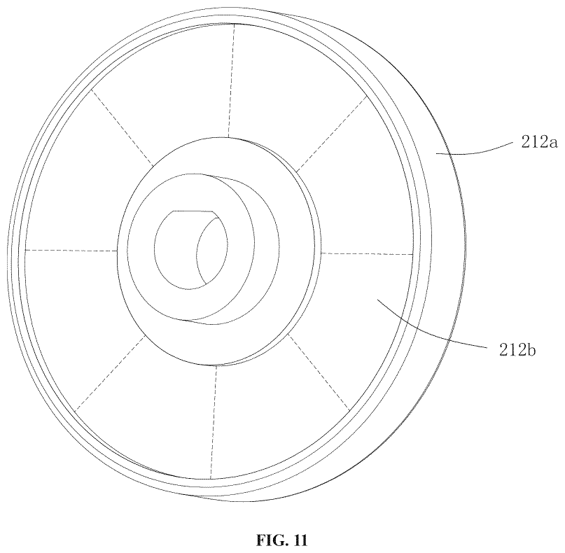

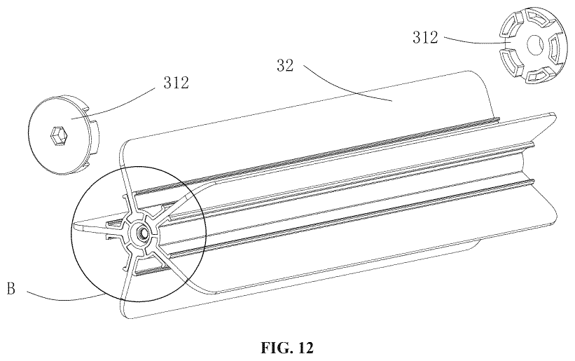

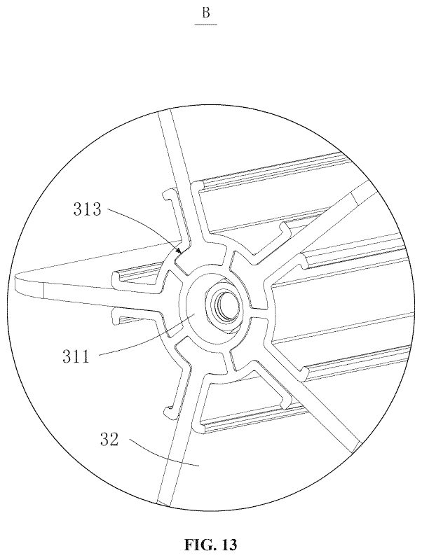

As shown in FIG. 1 to FIG. 13, an embodiment of the present application provides a water surface cleaning machine 100, including a machine body 10, a drive assembly 20, and a roller brush assembly 30.

The machine body 10 includes a housing 11 and a sealed casing 12 that is arranged inside the housing 11 and isolated from an outside. The drive assembly 20 includes a first drive member 21 and a second drive member 22. The first drive member 21 is arranged inside the sealed casing 12, the second drive member 22 is arranged inside the housing 11 and is arranged outside the sealed casing 12, and the first drive member 21 is magnetically connected with the second drive member 22. The roller brush assembly 30 is arranged on the second drive member 22, and is configured to rotate with the second drive member 22 when the first drive member 21 operates.

Specifically, the housing 11 serves as an external protective structure for the water surface cleaning machine, and can play a supporting and protective role and prevent the external clutters from directly contacting the internal components. The sealed casing 12 is located inside the housing 11, and is completely isolated from an external environment. The sealed casing accommodates the first drive member 21 to ensures that the first drive member is in a dry and sealed environment and prevented from being penetrated by a water vapor or a liquid. Through the design of the sealed casing 12, a motor 211 is completely isolated from an external water environment, which fundamentally solves the problems such as short-circuiting and corrosion of the traditional water surface cleaning machines caused by the penetration of water into the motor 211, and significantly improves the water proofing performance and reliability of the machine.

Further, the second drive member 22 is located outside the sealed casing 12, and is magnetically connected with the first drive member 21 to transmit a power to the roller brush assembly 30. Thus, the non-contact power transmission is achieved through magnetic coupling, which avoids the shaft sealing problem in the conventional mechanical transmissions. The magnetic driving mode does not require a mechanical contact, and completely eliminates the friction and wear between the traditional transmission shaft and sealing ring, which reduces the maintenance cost and extends the life of the machine. The non-contact transmission avoids the risk that a water vapor penetrates into the motor 211 along a transmission shaft, and further improves the water proofing performance.

In a specific embodiment, the first drive member 21 includes a motor 211 arranged in the sealed casing 12 and a first magnetic ring 212 in a transmission connection with the motor 211, and the first magnetic ring 212 is in bearing-type connection with the sealed casing 12.

The second drive member 22 includes a second magnetic ring 221, central axes of the first magnetic ring 212 and the second magnetic ring 221 are located on a same straight line, and there is a gap 23 between the second magnetic ring 221 and the sealed casing 12.

Specifically, the first magnetic ring 212 is supported by a bearing, such that the first magnetic ring can rotate smoothly, the friction can be reduced, and the transmission efficiency can be improved. The bearing reduces the rotating resistance to make the magnetic transmission stable and efficient. The bearing supporting structure prevents the wear for the magnetic ring due to deflection, and improves the durability of the machine. The second magnetic ring 221 serves as an external drive component, and forms a magnetic coupling with the first magnetic ring 212 to achieve the non-contact power transmission.

Further, magnetic coupling directions of the two magnetic rings remain consistent to ensure the stable and efficient torque transmission, thereby ensuring the maximum magnetic transmission efficiency and minimizing the energy loss. The coaxial arrangement makes a magnetic coupling force evenly distributed, and reduces the vibration or transmission instability caused by deflection. The first magnetic ring 212 and the second magnetic ring 221 are separated through a specified gap 23, which can prevent the physical contact friction while allowing the magnetic transmission. When an external roller brush is stuck by foreign matters, a torque transmitted between the magnetic rings is not enough to clean up the foreign matters, the second magnetic ring 221 stops rotating, and the motor 211 can continue to rotate, which prevents the situation that the motor 211 is stalled and burned out.

In a specific embodiment, the first magnetic ring 212 includes a first supporting member 212a and a plurality of first magnets 212b arranged circularly on the first supporting member 212a, and a first separator 212c is provided between two adjacent first magnets 212b.

The second magnetic ring 221 includes a second supporting member 221a and a plurality of second magnets 221b arranged circularly on the second supporting member 221a, and a second separator 221c is provided between two adjacent second magnets 221b. Each first magnet 212b directly faces a corresponding second magnet 221b, and the plurality of first magnets 212b have an opposite magnetic pole to the plurality of second magnets 221b.

Specifically, the first supporting member 212a serves as a fixing base for the magnets to ensure that the magnets are arranged neatly and are firmly supported. The first magnets 212b are arranged circumferentially to allow the even distribution of magnetic fields and enhance the stability of magnetic coupling, thereby improving the uniformity of the magnetic field, reducing the magnetic loss, and improving the transmission efficiency. The supporting members fix the magnets to prevent the magnets from loosening or deflecting due to a vibration or an external force, which improves the reliability of the system. The first separator 212c is configured to separate adjacent magnets and prevent magnetic fields from interfering with each other.

Further, the second magnetic ring 221 has a similar structure to the first magnetic ring 212, and the supporting member of the second magnetic ring fixes the second magnets 221b. The second magnetic ring forms a magnetic coupling with the first magnetic ring 212. Due to a magnetic coupling effect, when the first magnetic ring 212 rotates, the second magnetic ring 221 rotates synchronously, which allows the non-contact transmission. The attraction between opposite magnetic poles results in a stable magnetic coupling to achieve the efficient torque transmission. Each first magnet 212b directly faces a corresponding second magnet 221b to make magnets on the first magnetic ring 212 and the second magnetic ring 221 tightly aligned, such that magnetic fields can interact with each other to the maximum extent and the efficient magnetic coupling transmission can be allowed.

In a specific embodiment, each of the plurality of first magnets 212b includes a positive pole portion and a negative pole portion, and the positive pole portions and the negative pole portions, facing one side of the second magnet 221b, of the plurality of first magnets 212b are staggered.

Specifically, the magnets on the first magnetic ring 212 are arranged in a staggered manner, that is, positive pole portions and negative pole portions of adjacent magnets are staggered to form a stable alternating magnetic field. The staggered arrangement can make magnetic fields distributed evenly, reduce the disorders of magnetic fields, and improve the stability of magnetic coupling. The staggered arrangement can reduce the non-uniformity caused by the concentration of magnetic fields at a side and improve the magnetic field alignment effect, thereby improving the magnetic transmission ability.

In another specific embodiment, the first magnetic ring 212 and the second magnetic ring 221 both are complete magnetic rings, and different magnetic poles are introduced on the magnetic rings in a staggered manner to achieve the staggered arrangement of a plurality of magnets. The directional magnetization process adopted in a manufacturing process is a prior art, which is not repeated here. Magnetic poles of the first magnetic ring 212 and the second magnetic ring 221 correspond to each other, which improves the magnetic coupling effect.

In a specific embodiment, the sealed casing 12 includes a separating portion 123 and a first casing 121 and a second casing 122 that are arranged at two sides of the separating portion 123, respectively. The first casing 121 and the separating portion 123 enclose a first cavity 124, and the second casing 122 and the separating portion 123 enclose a second cavity 125.

The motor 211 is arranged in the first cavity 124 and partially extends into the second cavity 125, and the first magnetic ring 212 is arranged in the second cavity 125.

Specifically, the sealed casing 12 includes a separating portion 123, a first casing 121, and a second casing 122, which form an independent cavity structure. The separating portion 123 plays a structural support role, and can also lead to a physical separation between the first cavity 124 and the second cavity 125 to avoid the mutual interference. The sealed casing 12 is divided by the separating portion 123 into two cavities, which achieves the reasonable allocation of the internal space and facilitates the arrangement and maintenance of the motor 211 and the magnetic rings. The separating portion 123 serves as a core supporting structure for the sealed casing, and provides a stable assembling base plane for the first casing 121 and the second casing 122. The components are ensured to be arranged at accurate positions during an assembly process, which can reduce the sealing failure or performance degradation due to misplacement, reduce the assembly difficulty, and improve the production efficiency.

Further, a transmission shaft of the motor 211 passes through the separating portion 123, extends into the second cavity 125, and is connected with the first magnetic ring 212, thereby allowing the power transmission. The first magnetic ring 212 is located in the second cavity 125, and is magnetically coupled with the second magnetic ring 221 to drive the roller brush assembly 30 to rotate. The motor 211 is directly connected with the first magnetic ring 212 to ensure the accuracy and stability of power transmission. The motor 211 only partially extends into the second cavity 125, and the second cavity 125 is isolated from an external environment, which reduces the possibility of a water vapor to penetrate into the motor 211.

In a specific embodiment, a first sealing groove 123a and a second sealing groove 123b are annularly formed at two opposite sides of the separating portion 123, respectively.

The drive assembly 20 further includes a sealing member 24, and the sealing member 24 is arranged in the first sealing groove 123a and the second sealing groove 123b. The first casing 121 extends into the first sealing groove 123a and is in an interference fit with the sealing member 24, and the second casing 122 extends into the second sealing groove 123b and is in an interference fit with the sealing member 24.

Specifically, the first sealing groove 123a and the second sealing groove 123b are formed at the two sides of the separating portion 123 respectively for arranging the sealing member 24 to form an effective sealing structure. The sealing grooves are distributed annularly, such that the sealing member 24 can fit evenly to achieve the 360° all-round sealing, which improves the sealing effect. The annular design can reduce the local stress concentration, improve the service life of the sealing member 24, and prevent the leakage risk caused by an uneven local force.

Further, the sealing grooves 123a and 123b are arranged at two sides of the separating portion 123 respectively to form two sealing interfaces. Functions of the sealing grooves are to accommodate the sealing member, provide an effective sealing barrier, prevent the moisture, dust, or clutters from entering an inside of a drive system, and avoid the damage or dysfunction due to the influence of an external environment. The sealing member 24 is a key component to fill the sealing grooves and be in an interference fit with the casings. The sealing member 24 is usually made of a material with excellent elasticity (such as a rubber and a silicone rubber), which can effectively prevent the leakage of a liquid to ensure the normal operation.

In a specific embodiment, the first casing 121 includes a body 121a and a clamping portion 121b integrally formed with the body 121a. A side of the first casing 121 that is close to the separating portion 123 extends outwards to produce the clamping portion 121b. The clamping portion 121b clamps the separating portion 123.

The drive assembly 20 further includes a fixing member 25, and the fixing member 25 is arranged to penetrate through the first casing 121, the separating portion 123, and the second casing 122 successively and is configured to fix the first casing 121, the separating portion 123, and the second casing 122.

Specifically, the clamping portion 121b enhances a connection force between the casings and the separating portion 123 through a physical clamping force, and avoids the loosening of components caused by a vibration of the machine or an external force, thereby ensuring the structural stability of the machine. The design of the clamping portion 121b can greatly simplify the assembly process, avoid the complicated connectors or tools, and reduce the time costs of manufacturing and assembly.

Further, the design of the clamping portion 121b enables the first casing 121 and the separating portion 123 to be pre-fixed during an assembly process. This means that the clamping portion 121b has ensured the initial connection between the two components before the fixing member 25 is arranged, which avoids the relative displacement or misplacement of the components during the assembly process. The fixing member 25 is designed to penetrate through the first casing 121, the separating portion 123, and the second casing 122 successively, such that the three components can be quickly and accurately fixed as a whole. This design reduces the possible errors during disassembling and assembling processes while making the entire assembling process efficient.

Further, the penetration arrangement of the fixing member 25 ensures the connection stability of the first casing 121, the separating portion 123, and the second casing 122, such that the integrity and sealing performance of the machine are significantly improved. The sealing member 24 can also be well supported and fixed in this process, which further enhances the sealing performance such as water proofing and dust proofing performance.

In a specific embodiment, the roller brush assembly 30 includes a roller brush shaft 31 and flexible roller brush blades 32 arranged circularly on the roller brush shaft 31, and the second drive member 22 is fixedly connected with the roller brush shaft 31.

The roller brush shaft 31 includes a cylinder 311 and end covers 312. Fixing grooves 313 are formed annularly and circumferentially on the cylinder 311 in a length direction of the cylinder. The end covers 312 cover two ends of the cylinder 311 respectively to enclose two ends of each fixing groove 313. The flexible roller brush blades 32 are arranged in the fixing grooves 313.

Specifically, the roller brush shaft 31 is a core component of the roller brush assembly 30, and the roller brush shaft is responsible for supporting and fixing the roller brush blades and transmitting a power from the second drive member 22. The flexible roller brush blades 32 are arranged circularly on the roller brush shaft 31, and can flexibly follow the surface changes, which avoids the problem that hard roller brush blades may be stuck when encountering large and hard garbage.

In a specific embodiment, the flexible roller brush blades 32 are flexible silicone rubbers.

Further, the fixing grooves 313 formed annularly and circumferentially on the cylinder 311 in the length direction provide fixed arrangement positions for the flexible roller brush blades 32. As a result, the roller brush blades can be firmly fixed on the roller brush shaft 31, and thus can be prevented from sliding or falling off when in use. The end covers 312 cover the two ends of the cylinder 311 to enclose two ends of each fixing groove 313, respectively. This design ensures the stability of the roller brush blades, and avoids the loosening or falling off of the roller brush blades due to an external force during an operation. Through the structural designs of the fixing grooves 313 and the end covers 312, the roller brush blades can be arranged accurately, which enhances the stability and reliability of the entire roller brush assembly 30.

In a specific embodiment, the fixing grooves 313 are convex, limit a degree of freedom for the flexible blades through the end covers 312 in the length direction of the roller brush shaft 31, and abut against the flexible roller brush blades through convex edges. Connecting ends of the flexible roller brush blades with the roller brush shaft 31 correspond to shapes of the fixing grooves 313, and limit a degree of freedom for the blades in an axis direction perpendicular to the roller brush shaft 31.

In a specific embodiment, the water surface cleaning machine further includes a storage bin 40. The storage bin 40 is slidably connected with the housing 11. The roller brush assembly 30 is arranged on the storage bin 40 and partially extends out of a side wall of the storage bin 40. Two ends of the roller brush assembly 30 are in bearing-type connection with the side wall of the storage bin 40, respectively.

Specifically, the storage bin 40 is slidably connected with the housing 11, such that the storage bin can be conveniently stretched out or retracted from an outside of the machine when in need. The roller brush assembly 30 is in bearing-type connection with both ends of the storage bin 40, which can effectively improve the stability and reliability. This design ensures that the roller brush can operate stably during a cleaning process, and the clutters can be prevented from being pushed disorderly, which ensures the cleaning effect. Through the bearing-type connection, the friction and wear for the roller brush in a transmission process can also be reduced, which prolongs the service life of the roller brush and further guarantees the stability of magnetic connection between the roller brush and the drive assembly 20.

In a specific embodiment, the storage bin 40 further includes a storage portion 41 and a blocking portion 42. The roller brush assembly 30 is arranged on the storage portion 41. The blocking portion 42 is arranged at an end of the storage portion 41 that is close to the roller brush assembly 30, and is configured to prevent clutters from entering a shaft connection between the roller brush assembly 30 and the storage portion 41.

Specifically, the storage portion 41 is configured to accommodate a clutter or garbage that is cleaned by the roller brush assembly 30. The roller brush assembly 30 is fixed on the storage portion 41, which ensures that the garbage can be effectively introduced into the storage bin 40 during a cleaning process. The arrangement of the blocking portion 42 at an end of the storage portion 41 that is close to the roller brush assembly 30 can effectively prevent the clutters from making a shaft connection between the roller brush assembly 30 and the storage portion 41 stuck or clogged, thereby reducing the mechanical failure or non-smooth operation problem caused by the clutters entering a bearing region and prolonging the service life of the machine.

The above are merely implementations of the present application. It should be noted here that those of ordinary skill in the art may make modifications without departing from the inventive concept of the present application, but such modifications should all fall within the protection scope of the present application.

What is claimed is:

1. A water surface cleaning machine, comprising:
a machine body, comprising a housing and a sealed casing that is arranged inside the housing and isolated from an outside;
a drive assembly, comprising a first drive member and a second drive member, wherein the first drive member is arranged inside the sealed casing, the second drive member is arranged inside the housing and is arranged outside the sealed casing, and the first drive member is magnetically connected with the second drive member; and
a roller brush assembly that is arranged on the second drive member and is configured to rotate with the second drive member when the first drive member operates.

2. The water surface cleaning machine according to claim 1, wherein the first drive member comprises a motor arranged in the sealed casing and a first magnetic ring in a transmission connection with the motor, and the first magnetic ring is in bearing-type connection with the sealed casing; and
the second drive member comprises a second magnetic ring, central axes of the first magnetic ring and the second magnetic ring are located on a same straight line, and there is a gap between the second magnetic ring and the sealed casing.

3. The water surface cleaning machine according to claim 2, wherein the first magnetic ring comprises a first supporting member and a plurality of first magnets arranged circularly on the first supporting member, and a first separator is provided between two adjacent first magnets; and
the second magnetic ring comprises a second supporting member and a plurality of second magnets arranged circularly on the second supporting member, and a second separator is provided between two adjacent second magnets; and each first magnet directly faces a corresponding second magnet, and the plurality of first magnets have an opposite magnetic pole to the plurality of second magnets.

4. The water surface cleaning machine according to claim 3, wherein each of the plurality of first magnets comprises a positive pole portion and a negative pole portion, and the positive pole portions and the negative pole portions, facing one side of the second magnet, of the plurality of first magnets are staggered.

5. The water surface cleaning machine according to claim 2, wherein the sealed casing comprises a separating portion and a first casing and a second casing that are arranged at two sides of the separating portion, respectively; the first casing and the separating portion enclose a first cavity, and the second casing and the separating portion enclose a second cavity; and
the motor is arranged in the first cavity and partially extends into the second cavity, and the first magnetic ring is arranged in the second cavity.

6. The water surface cleaning machine according to claim 5, wherein a first sealing groove and a second sealing groove are annularly formed at two opposite sides of the separating portion, respectively; and
the drive assembly further comprises a sealing member, and the sealing member is arranged in the first sealing groove and the second sealing groove; and the first casing extends into the first sealing groove and is in an interference fit with the sealing member, and the second casing extends into the second sealing groove and is in an interference fit with the sealing member.

7. The water surface cleaning machine according to claim 5, wherein the first casing comprises a body and a clamping portion integrally formed with the body; a side of the first casing that is close to the separating portion extends outwards to produce the clamping portion; the clamping portion clamps the separating portion; and
the drive assembly further comprises a fixing member, and the fixing member is arranged to penetrate through the first casing, the separating portion, and the second casing successively and is configured to fix the first casing, the separating portion, and the second casing.

8. The water surface cleaning machine according to claim 1, wherein the roller brush assembly comprises a roller brush shaft and flexible roller brush blades arranged circularly on the roller brush shaft, and the second drive member is fixedly connected with the roller brush shaft; and
the roller brush shaft comprises a cylinder and end covers; fixing grooves are formed annularly and circumferentially on the cylinder in a length direction of the cylinder; the end covers cover two ends of the cylinder respectively to enclose two ends of each fixing groove;
and the flexible roller brush blades are arranged in the fixing grooves.

9. The water surface cleaning machine according to claim 1, further comprising a storage bin, wherein the storage bin is slidably connected with the housing; the roller brush assembly is arranged on the storage bin and partially extends out of a side wall of the storage bin; and two ends of the roller brush assembly are in bearing-type connection with the side wall of the storage bin, respectively.

10. The water surface cleaning machine according to claim 9, wherein the storage bin further comprises a storage portion and a blocking portion; the roller brush assembly is arranged on the storage portion; and the blocking portion is arranged at an end of the storage portion that is close to the roller brush assembly, and is configured to prevent clutters from entering a shaft connection between the roller brush assembly and the storage portion.
